(19) United States
(12) Patent Application Publication
(10) Pub. No.: US 2013/0030918 A1
(43) Pub. Date: Jan. 31, 2013

(54) System and Method for Providing Indications of Participating Advertisers to a Portable User Device

(71) Applicants: Manoj Mourya, Fremont, CA (US); Sergio Catanzariti, San Francisco, CA (US)

(72) Inventors: Manoj Mourya, Fremont, CA (US); Sergio Catanzariti, San Francisco, CA (US)

(73) Assignee: FRANCE TELECOM, Paris (FR)

(21) Appl. No.: 13/520,081

(22) PCT Filed: Dec. 23, 2010
(86) PCT No.: PCT/IB2010/003507

§ 371 Date: Oct. 15, 2012

Related U.S. Application Data
(60) Provisional application No. 61/291,352, filed on Dec. 30, 2009.

(51) Int. Cl. G06Q 30/02

(52) U.S. Cl. 705/14.58

(57) ABSTRACT

A method of providing indications of participating advertisers to a portable user device including detecting a plurality of participating advertisers in a vicinity of the portable user device; determining a relative proximity of the portable user device to each of the plurality of the participating advertisers; rendering an indication of the participating advertisers on the portable user device to convey the determined relative proximity of each of the plurality of the participating advertisers; detecting a change in the relative proximity of the participating advertisers; and changing the rendering of the participating advertisers on the portable user device to convey the detected change in the relative proximity of the participating advertisers.

### CROSS-REFERENCE TO RELATED APPLICATIONS

This Application is a Section 371 National Stage Application of International Application No. PCT/IB2010/003507, filed Dec. 23, 2010, which is incorporated by reference in its entirety and published as WO 2011/080596 on Jul. 7, 2011, in English, which is based on and claims the benefit of U.S. provisional patent application Ser. No. 61/291,352, filed Dec. 30, 2009, the content of which is hereby incorporated by reference in its entirety.

### STATEMENT REGARDING FEDERALLY SPONSORED RESEARCH OR DEVELOPMENT None.

### THE NAMES OF PARTIES TO A JOINT RESEARCH AGREEMENT

None.

### FIELD OF THE PRESENT SYSTEM

The present system is directed to a user interface for providing store coupons to consumers, and more specifically, a user interface to enable consumers to access coupons and advertisements of stores or shops automatically as they approach the stores vicinities.

### BACKGROUND OF THE PRESENT SYSTEM

There are systems showing delivery of local advertisements in malls. However, these systems rely on location based technologies that identify a location of a user device and provide information on goods and services within a proximity of the user device. These systems all utilize knowledge of a users location, e.g., GPS coordinates, to identify where the user is located. The user location is then compared to a database of the goods and services that are available which are associated with information that identifies the location of the goods or services. For example, U.S. Pat. No. 6,587,835, incorporated herein as if set out in its entirety, describes determining the location of the consumer using the GPS or arranging a number of local wireless transmitter/receivers to overlap to form a wireless local area network. The location of the user is determined by identifying the local wireless transmitter/receiver with which a handheld computing device is in communication. While this system provides a framework for providing location based services (LBSs), it requires a complex infrastructure of a communication network and the difficulties associated with maintaining it. In addition, this system provides no user interface that facilitates delivery of information that may be more relevant to the user than other information related to a given location.

U.S. Patent Publication No. 2008/0040219, incorporated herein as if set out in its entirety, shows using wireless transceivers for creation of a Wireless Personal Area Network for use by retailers or advertisers and mesh networking to route data, voice and instructions between various point of presence nodes, allowing for continuous connections and reconfiguration around broken or blocked paths by “hopping” from node to node until the destination is reached. However, this system again requires a complex infrastructure and provides no user interface that facilitates delivery of particularly relevant information to the user.

Accordingly, there is a need for a system to provide a simple user interface that provides particularly relevant information to a user. Further, there is a need to provide a coordinate free location based service that does not require building of networks shared by multiple businesses or that require user held devices to include expensive hardware or services like the GPS or tower based location determination.

### SUMMARY OF THE PRESENT SYSTEM

In accordance with an embodiment of the present system, the method may include providing indications of participating advertisers to a portable user device, detecting a plurality of participating advertisers in a vicinity of the portable user device; determining a relative proximity of the portable user device to each of the plurality of the participating advertisers; rendering an indication of the participating advertisers on the portable user device to convey the determined relative proximity of each of the plurality of the participating advertisers; detecting a change in the relative proximity of the participating advertisers; and changing the rendering of the participating advertisers on the portable user device to convey the detected change in the relative proximity of the participating advertisers. The method may include identifying notification information that corresponds to each of the plurality of participating advertisers, wherein rendering the indication of the participating advertisers includes rendering the identified notification information.

In one embodiment, changing the rendering of the participating advertisers includes changing a rendered transparency of the participating advertisers such that a first participating advertiser that moves closer to the user device than a previously closer second participating advertiser will have its rendered transparency change from more transparent to less transparent than the previously closer second participating advertiser. In another embodiment, changing the rendering of the participating advertisers may include changing a rendered size of the participating advertisers such that a first participating advertiser that moves closer to the user device than a previously closer second participating advertiser will have its rendered size change from smaller to larger than the previously closer second participating advertiser.

In accordance with an embodiment of the present system, at least one beacon device may be installed for each one of the plurality of participating advertisers, wherein the beacon device sends out a signal identifying which one of the participating advertisers is associated with the beacon device. In this embodiment, detecting the plurality of participating advertisers may include detecting the signals from the beacon devices. In a further embodiment, the beacon devices may be standalone transmitters operating on a same frequency. The beacon devices may have a same Service Set Identifier (SSID) and a unique Medium Access layer (MAC) address that identifies each of the plurality of the participating advertisers. In a further embodiment, the beacon devices may use option fields in an internet protocol (IP) compliant header to identify each of the plurality of the participating advertisers.

In one embodiment, each of the beacon devices may be registered at a vendor provisioning portal associating unique notification information for each of the plurality of the participating advertisers at the vendor provisioning portal. In this embodiment, rendering the indication of the participating advertisers may include rendering the associated notification information. Further, determining the relative proximity and detecting the change in the relative proximity may include detecting a relative signal strength of each of the beacon devices. The indication of the participating advertisers may include coupons.

The method may further include retrieving notifications of similar advertisers as the plurality of the participating advertisers; and rending the notifications of the similar advertisers. The method may include providing a comparison of the similar advertisers to the plurality of the participating advertisers. In one embodiment, at least one of the plurality of the participating advertisers that is compared may have a beacon device and at least one of the similar advertisers may be a web based store. The method may include providing a coupon indication of one of the participating advertisers on a plurality of portable user devices that are each in proximity to the one of the participating advertisers, wherein the coupon indication is associated with a subsequent redemption for at least one of a good and service of the one of the participating advertisers.

### BRIEF DESCRIPTION OF THE DRAWINGS

The present system is explained in further detail, and by way of example, with reference to the accompanying drawings wherein:

FIG. 1 is a map illustrating locations of stores in a mall and identifying stores having transmitters (Vid transmitters) in accordance with an embodiment of the present system;

FIG. 2 is an illustration of a user interface rendered on a user device displaying advertiser information in accordance with an embodiment of the present system;

FIG. 3 is an illustration of a user interface rendered on a user device displaying advertiser information in accordance with an embodiment of the present system; and

FIG. 4 is an illustrative user device in accordance with an embodiment of the present system.

### DETAILED DESCRIPTION OF THE PRESENT SYSTEM

The system of the present system can be explained with a following example, a consumer who uses a portable computing device, e.g., an iPhone, connected to a network through, for example a subscription to a cell phone service. In operation, the user may go to an area where a plurality of participating advertisers are located, such as a shopping mall. Approaching a participating advertiser, the user may enable execution of an application on a user device that operates in accordance with the present system. The application may use circuitry on the user device to detect the first participating advertiser and load notices, such as coupons and advertisements related to that particular participating advertiser onto a user interface of the user device. The consumer is thus enabled to review solicitations offered by the first participating advertiser without even going inside the store of the participating advertiser.

After reviewing the provided solicitation information, the user may decide to check deals at a different, second participating advertiser nearby. As the user walks away from the first participating advertiser, the application of the present system in accordance with an embodiment of the present system advertisements from the first participating advertiser may be deemphasized in relation to advertisements associated with the second participating advertiser. For example, an ordering of advertisements may be adjusted such that advertisements from the second participating advertiser are moved on a list of advertisements rendered on the user device, from below the advertisements associated with the first participating advertiser to above the advertisements associated with the first participating advertiser. In accordance with a further embodiment of the present system, a transparency of rendered advertisements may be adjusted such that advertisements from a closer participating advertiser are rendered less transparent than advertisements from a participating advertiser that is further from the user device. In another embodiment of the present system, the user interface rendered on the user device may provide a user interface that emphasis/deemphasizes notifications by rendering indications that are associated with participating advertisers that are more proximate to the user device to appear as being rendered in a foreground of the user interface (e.g., larger and/or more sharp) while rendering indications that are associated with participating advertisers that are relatively less proximate to the user device to appear as being rendered in a background of the user interface (e.g., smaller and/or relatively less sharp). In yet a further embodiment of the present system, advertisements from a participating advertiser that is further from the user device may be removed from the user device and replaced by advertisements from the closer second participating advertiser.

In accordance with the present system, the solicitation, such as coupons, appear dynamically (e.g., automatically) in real-time as the user approaches participating advertiser and become deemphasized (e.g., disappear, become more transparent, move into a background portion of the rendered user interface, etc.) when the user moves away from a participating advertiser. In accordance with an embodiment of the present system, any solicitations selected by the user may be retained within the user interface of the user device, for example at the option of the user, for a predetermined time or until an expiration of the solicitation as for example, selectable by the participating advertiser.

While the present system may operate with use of an existing wireless network, such as a WiFi network of the participating advertisers, in accordance with an embodiment of the present system, other components may operate to enable the present system. For example, a participating advertiser may deploy in the immediate vicinity of the participating advertiser, a vendor id (Vid) transmitter installed at participating advertisers sites (e.g., vendors' sites), i.e., at the store fronts. Further and regardless of how a proximity of the participating advertiser to the user device is determined, a database (e.g., a vendor provisioning portal (VPP)) is provided such that the participating advertisers solicitations may be presented to the user through use of a user interface provided on the user device. The VPP in accordance with the present system provides access to a database that associates a given participating advertiser with notification information. For example, the VPP may be stored on a server that is accessible to the user device over the Internet.

In accordance with this embodiment of the present system, the Vid transmitter maybe a standalone device that requires only a power connection, having no other interfaces for interacting with the Vid transmitter. For example, in accordance with this embodiment, the Vid transmitters need not operate within a network (e.g., such as a local area network, wide area network) and in fact, need not receive transmissions for operation since all that is needed, is that the Vid transmitters provide the user device a system for determining a proximity to the participating advertisers including a relative proximity amongst the participating advertisers. For example, each of the Vid transmitters may operate on a same frequency as each other of the Vid transmitters.

In accordance with an embodiment of the present system, the Vid transmitter may have a range of coverage similar to, and use a similar transmission protocol as a Wi-Fi access point (802.11a/b/g/n), however, have no need for being enabled to receive transmissions. In accordance with a further embodiment of the present system, all the Vid transmitters may utilize a same Service Set Identifier (SSID), yet utilize a unique name identifying a given Vid transmitter, thereby differentiating it from other Vid transmitters. In accordance with a further embodiment of the present system, the Vid transmitters may not utilize an operating system and may only include transmitters that are configured for transmitting information that may be utilized by a user device for identifying the participating advertiser associated with a given Vid transmitter.

In accordance with an embodiment of the present system wherein a WiFi compliant transmission protocol is utilized by a Vid transmitter, option fields in the internet protocol (IP) header may be used to transmit information from the Vid transmitters to an application of the present system residing on the user device. In accordance with an embodiment of the present system, other Wi-FI capable devices may connect to a Vid transmitter at a physical layer, for example without requiring passwords. However, the Vid transmitter of the present system need operate as a wireless receiver, and as such, need not operate as an Internet access device and as discussed herein, need not connect to a network. In an embodiment of the present system wherein the Vid transmitters are also receivers, the Vid transmitters may utilize the option fields in an internet protocol (IP) communication to communicate (e.g., exchange information) with the user device.

In accordance with an embodiment of the present system, the Vid transmitter may be installed at a location of a participating advertiser, such as in a store of a participating advertiser. In accordance with the present system, a given participating advertiser has information identifying the participating advertiser stored in the VPP, such as by the participating advertiser registering with the VPP. After registering, the participating advertiser simply need connect the Vid transmitter, that is provisioned with an identifier that is unique to the given participating advertiser device, to a power outlet.

In this ways, participating advertisers may use the VPP to publish their solicitation, such as advertisements, such that consumers can access the solicitations when they are in the proximity of the participating advertiser. In accordance with an embodiment of the present system, once a participating advertiser is registered to the VPP, the VPP may search the Internet to provide more coupons and deals to the user that are related to the registered participating advertiser.

In accordance with an embodiment of the present system, the VPP may store all the information related to participating advertisers including related information that may be determined by searching for additional information related to the participating advertiser through, for example, an Internet search of the participating advertiser. As may be readily appreciated by a person of ordinary skill in the art, more intelligence may be added to the VPP to offer additional innovative services related to the participating advertiser, such as providing to the user device a telephone number associated with the participating advertiser.

In accordance with an embodiment of the present system, while all Vid transmitters may utilize the same SSID, their hardware addresses or Medium Access layer (MAC) addresses are unique so that the present system may identify each of the participating advertisers. For example, MAC is a standard protocol used in all the networking devices. In accordance with this embodiment of the present system, there is a one to one mapping between the participating advertiser and the MAC address of the participating advertiser's Vid transmitter. In this embodiment, the Vid transmitter of each participating advertiser has a unique MAC address. The MAC addresses may be assigned to the participating advertiser when the participating advertiser registers with the VPP. In this embodiment, this MAC address is utilized by a user device to identify one or more participating advertisers that are in proximity to the user device.

In accordance with this embodiment, like a typical Wi-Fi device, each store's Vid transmitter may regularly transmit the SSID and MAC address. In this way, any user device that has an ability to receive a Wi-Fi transmission, can detect the Vid transmitter of the participating advertisers including the participating advertisers unique MAC addresses. Once the participating advertisers unique MAC addresses is determined by the application of the present system running on the user device, the user device may process the MAC address and get the solicitation information of the participating advertiser associated with the unique MAC address.

In this way, the present system need not identify a coordinate location of the participating advertiser such as is required by prior systems since all that is utilized by the present system is an ability to identify that a participating advertiser is in a proximity of the user device. In accordance with a further embodiment of the present system, the present system need only have an ability to distinguish which of a plurality of participating advertisers is closest to the user device. In accordance with a still further embodiment of the present system, the present system need only have an ability to determine a relative closeness of the participating advertisers to the user device. In this way, the present system may be utilized to provide co-ordinate free location based services.

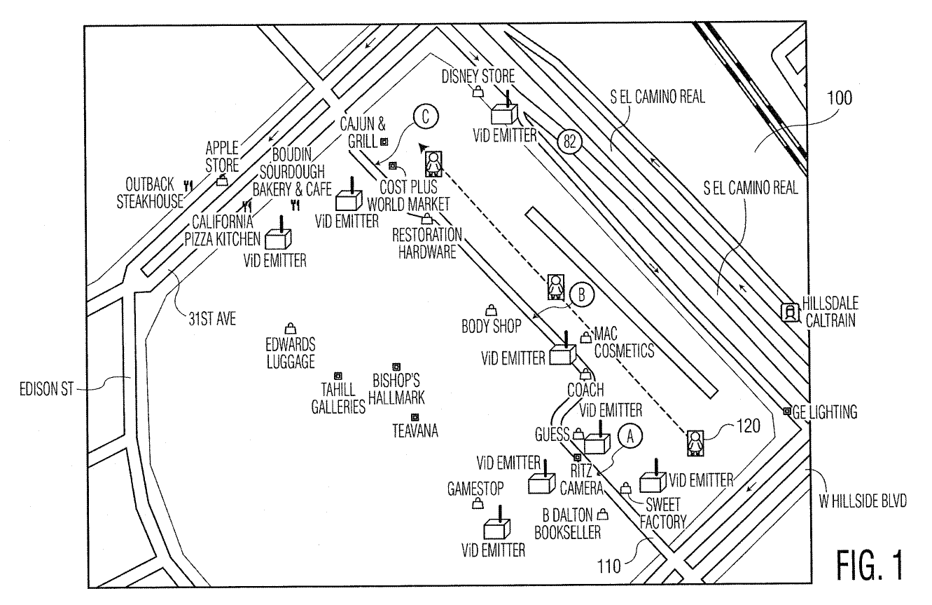

The present system will now be described with reference to FIG. 1 which shows a map 100 illustrating locations of stores in a mall and identifying stores having transmitters (e.g., participating advertisers that have installed Vid transmitters) in accordance with an embodiment of the present system.

In operation of the illustrative embodiment, a user 120 may be walking inside a mall with a user device, e.g., an iPhone, loaded with an application of the present system. In accordance with an embodiment, the user may start the application or the application may be started by detection that one or more participating advertisers are in the vicinity of the user device. In any event and regardless of how the application is started, the user may walk throughout the mall including walking from point A to point B to point C (generally designated in FIG. 1) while the user 120 travels along a walkway 110. As the user 120 travels along the walkway 110, they may pass the following stores, including Sweet Factory, Guess, Coach, Mac cosmetics, Disney Store, Cost Plus World Market, Cajun Grill, B Dalton, GameStop, Ritz Camera, Teavana, Bishop's Hallmark, Tahil Galleries, Body Shop, Edward's Luggage, Restoration Hardware, Boudin Sourdough Bakery & Café, California Pizza Kitchen, Apple Store and Outback Steakhouse.

In accordance with the present system, the user device though programming provided in accordance with the present system, scans to detect one or more Vid transmitters that are within a detection range of the user device for corresponding SSID and MAC addresses. As discussed above, all Vid transmitters may utilize the same SSID, yet have unique MAC addresses. Using network connection features of the user device and the MAC addresses of the Vid transmitters, the application may connect to an Internet based VPP and retrieve solicitation information for each of the participating advertisers that have detected MAC addresses, including coupon details and special deals that may be rendered within a user interface provided on the user device. In accordance with a further embodiment of the present system, the user device may only retrieve solicitation information for two or more of the participating advertisers that have detected MAC addresses and that are closest to the user device.

In accordance with an embodiment of the present system, the user device may be able to detect a relative proximity between detected Vid transmitters to enable a determination of which amongst the detected Vid transmitters is closest to the user device. In accordance with a further embodiment of the present system, the user device may also be enabled to determine which detected Vid transmitter is next closest after the closest detected Vid transmitter, etc. For example, the user device may be programmed to detect a signal strength of the detected Vid transmitters to enable a determination of relative proximity between the detected Vid transmitters.

In this way, in accordance with an embodiment of the present system, the participating advertiser information may then be rendered on the user device within a user interface, in an order of, for example, strength of a signal from the participating advertisers Vid transmitters. In accordance with an embodiment of the present system, only advertisers with a Vid transmitter may have their information displayed on the user device. In this embodiment, the stronger the signal from the Vid transmitter, the closer the user is presumed to be to the location where that Vid transmitter is located. Of course, in accordance with an embodiment of the present system, the vendor information may be displayed in an other arrangement.

In accordance with a further embodiment of the present system, user devices (e.g., more than one user device, such as a predetermined number of users that are within a proximity of one of the plurality of the participating advertisers (e.g., 20 users in the proximity of the one of the plurality of the participating advertisers) may each be provided by the VPP with a notification in a form of coupon that may be redeemable immediately for a good or service or may be redeemable at a later time. The coupon may for example, enable a user of the user device to purchase a good and/or service associated with the one of the plurality of the participating advertisers at a discounted cost and/or may simply enable the user to purchase the good and/or service associated with the one of the plurality of the participating advertisers at a later time. In this way, each of the plurality of users that receive the coupon may similarly redeem the coupon.

In this way, the coupon can operate similar to a physical bracelet system as is known in the art wherein a bracelet or other physical object is provided to a user, for example that is standing in line to purchase the good and/or service. In this system, the bracelet may be turned in, typically at some later time, to enable the user to purchase the good and/or service. The coupon of this embodiment of the present system may be similarly rendered on the user devices that receive the coupon for presentation by the user devices at some later time to enable users to purchase or otherwise receive the good and/or service of a participating advertiser. For example, the coupon may be redeemable for the good and/or service without or without payment.

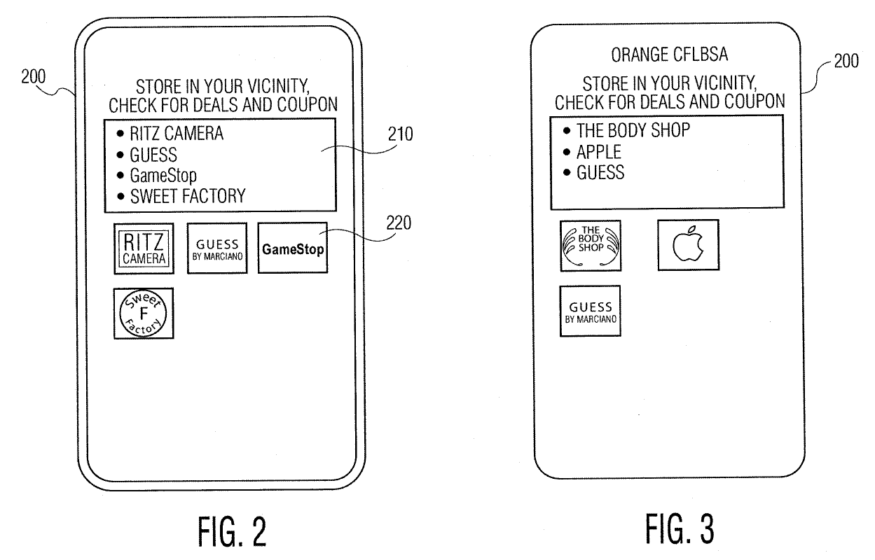

FIG. 2 is an illustration of a user interface rendered on a user device displaying participating advertiser information in accordance with an embodiment of the present system when the user 120 (see, FIG. 1) is positioned on the walkway 120 at a first position A. In FIG. 2, for example, an indication of Ritz Camera, Guess, GameStop and Sweet Factory are rendered on a user interface 210 (or portion of the user interface) of a device 200 in an order that is indicative of a relative distance of each of the participating advertisers to the user device 200. In accordance with this embodiment of the present system, Ritz Camera is closest to the user device 200, Guess is next closest, and GameStop is next closest, while the Sweet Factory is furthest away from the user device 200.

In accordance with an embodiment of the present system, icons of the detected participating advertisers may be rendered in a user interface 220 of the user device 200 once the participating advertiser solicitation information is loaded to the user device 200 from the VPP. In accordance with this embodiment, the icons of the detected participating advertisers may be utilized by the user to access the corresponding solicitation information. Naturally, in accordance with a further embodiment of the present system, the user interface 210 may be utilized for accessing the corresponding solicitation information. In a further embodiment, only one of the user interface 210 or the user interface 220 may be presented and utilized to access the corresponding solicitation information.

In accordance with the present system, as the user progresses from point A to point B, the application will scan the available Wi-Fi signals (e.g., continuously, periodically, in response to a newly detected participating advertiser and/or in response to a change in relative proximity of the participating advertisers), to detect Vid transmitters' SSIDs and collect corresponding MAC addresses.

As illustrated in FIG. 1, at point B only Mac cosmetics may be detected as in proximity to the user device 200 and as such, may be the only participating advertiser rendered on the user interface of the user device. In accordance with the present system, only stores having the Vid transmitter (or that are otherwise detectable by the user device) are rendered on the user device. Thus, although, Body Shop is in close proximity to point B, Body Shop is not a participating advertiser and as such, its solicitation information will not be rendered on the user device because it does not have the Vid transmitter (or is otherwise not detectable in accordance with the present system.

As the user progresses to point C, the user device may display a user interface 300 as illustrated in FIG. 3 which shows an illustration of a user interface rendered on a user device displaying advertiser information in accordance with an embodiment of the present system. As shown in FIG. 3, icons for Cost Plus World Market, the Disney Store, and California Pizza Kitchen will be rendered on the user device.

In this way, in accordance with an embodiment of the present system, advertisements from the participating advertisers that are determined to be further from the user device than an other participating advertiser, may be deemphasized in relation to advertisements associated with the other participating advertiser. For example, as a consumer walks from a first store (e.g., Guess) to a second store (e.g., Mac Cosmetics), an application executing on the user device may sense that a signal strength of the transmitter associated with Guess (e.g., located at the Guess store) is weakening and that a signal strength of the transmitter associated with the Mac Cosmetics (e.g., located at the Mac Cosmetics store) is increasing. In this way, in accordance with an embodiment of the present system, advertisements from Guess with the weaker signal may be deemphasized in relation to advertisements associated with the Mac Cosmetics. For example, an ordering of advertisements may be adjusted such that advertisements from Mac Cosmetics are moved on a list of advertisements rendered on the user device, from below the advertisements associated with Guess to above the advertisements associated with Guess. In this way, the user is provided a simple and intuitive way of identifying participating advertisers including a relative proximity of the participating advertisers and the corresponding rendered solicitation information.

In accordance with a further embodiment of the present system, a transparency of rendered indications of participating advertisers may be adjusted such that advertisements from a closer advertiser are rendered less transparent than advertisements from an advertiser that is further from the user device. In accordance with this embodiment, the transparency of rendered indications of participating advertisers may be adjusted as the relative proximity to the participating advertisers changes. For example, in accordance wherein the user interface 220 of FIG. 2 is utilized, the icons that are rendered may be rendered with a transparency that is related to the proximity of the participating advertisers to the user device 200.

In yet a further embodiment of the present system, advertisements from an advertiser that is further from the user device may be removed from the user device and replaced by advertisements from closer advertisers. For example, in accordance with an embodiment, the user may set an option indicating how many participating advertisers should be rendered on the user interface of the user device. This option may be useful in a case wherein many participating advertisers are in close proximity to the user device.

In accordance with an embodiment of the present system that utilizes Vid transmitters, a GPS location determination nor cell tower location service is required to determine the location of the user through the user device since in this embodiment, only the Vid transmitters are utilized to determine the proximity of participating advertisers. In accordance with the present system, relevant solicitation information (e.g., coupons and advertisements) may be always the latest because information since the solicitation information may downloaded in real-time as the consumer approaches participating advertisers. In this way, solicitations may be provided that are only relevant for short durations of time (e.g., sale coupon on one or more items of a participating advertiser that is only redeemable for the next 10 minutes) to encourage a user (or a predetermined number of users) to make use of the solicitations.

Moreover, since the VPP stores all participating advertiser solicitations including coupons, deals, address of participating advertiser and MAC addresses of the participating advertiser Vid transmitters, the application can retrieve that information from the VPP. In this way, a user is enabled to compare deals offered by different participating advertisers selling similar merchandise. In this way, the present system provides relevant comparison data to the consumer (e.g., only solicitation information related to participating advertisers that are in proximity to the user device) and may deliver to the consumer real physical address of participating advertisers offering a better bargain. In another embodiment of the present system, deals offered by participating advertisers in proximity to the user may be compared to deals that are offered through the Internet.

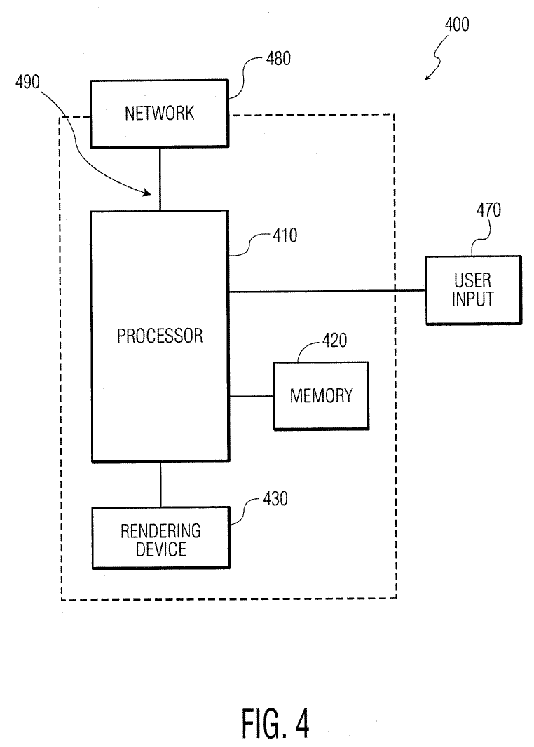

FIG. 4 shows a portion of a system 400 (e.g., user, VPP server, etc.) in accordance with an embodiment of the present system. For example, a portion of the present system may include a processor 410 operationally coupled to a memory 420, a display 430 and a user input device 470. The memory 420 may be any type of device for storing application data as well as other data related to the described operation. The application data and other data are received by the processor 410 for configuring (e.g., programming) the processor 410 to perform operation acts in accordance with the present system. The processor 410 so configured becomes a special purpose machine particularly suited for performing in accordance with the present system.

The operation acts may include detecting participating advertisers that are proximate to the user device 400, determining a relative proximity of participating advertisers, and/or rendering an indication of detected participating advertisers, etc. The user input 470 may include a keyboard, mouse, trackball or other device, including touch sensitive displays, which may be stand alone or be a part of a system, such as part of a personal computer, personal digital assistant, mobile phone, or other device for communicating with the processor 410 via any operable link. The user input device 470 may be operable for interacting with the processor 410 including enabling interaction within a UI as described herein. Clearly the processor 410, the memory 420, display 430 and/or user input device 470 may all or partly be a portion of a computer system or other device such as a user device and/or server as described herein.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 420 or other memory coupled to the processor 410.

The program and/or program portions contained in the memory 420 configure the processor 410 to implement the methods, operational acts, and functions disclosed herein. The memories may be distributed, for example between the clients and/or servers, or local, and the processor 410, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessible by the processor 410. With this definition, information accessible through a network is still within the memory, for instance, because the processor 410 may retrieve the information from the network for operation in accordance with the present system.

The processor 410 is operable for performing operations in response to input signals from the user input device 470 as well as in response to other devices of a network and executing instructions stored in the memory 420. The processor 410 may be an application-specific or general-use integrated circuit(s). Further, the processor 410 may be a dedicated processor for performing in accordance with the present system or may be a general-purpose processor wherein only one of many functions operates for performing in accordance with the present system. The processor 410 may operate utilizing a program portion, multiple program segments, or may be a hardware device utilizing a dedicated or multi-purpose integrated circuit.

Further variations of the present system would readily occur to a person of ordinary skill in the art and are encompassed by the following claims. Through operation of the present system, an indication of participating advertisers that are in proximity to a user device is provided to a user to enable the user to perceive participating advertiser solicitations.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. For example, while Vid transmitters where described to facilitate an indication of participating advertisers that are proximate to the user, other systems of determining a relative position of the user to participating advertisers may be readily applied. Further, while exemplary user interfaces are provided to facilitate an understanding of the present system, other user interfaces may be provided and/or elements of one user interface may be combined with another of the user interfaces in accordance with further embodiments of the present system. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts or steps is intended to be required unless specifically indicated; and
i) the term “plurality of” an element includes two or more of the claimed element, and does not imply any particular range of number of elements; that is, a plurality of elements may be as few as two elements, and may include an immeasurable number of elements.

An exemplary embodiment of the present system overcomes disadvantages and/or make improvements in the prior art.

An exemplary embodiment of the present system provides a simple user interface that provides notification of goods and services that are in the proximity to a user. The notification may be in a form of coupons and advertisements that may be delivered to consumers' computing devices, e.g., cell phones, as the individual consumers approach participating stores. For example, the present system may provide in a mall setting, advertisements to the consumer that become more prominent on a user interface of a user device when the consumer approaches a participating store since as the user comes closer and closer to the participating store, it becomes increasingly likely that the consumer has an intention to enter the store the participating store.

An exemplary embodiment of the present system provides a simple user interface that prioritizes notification of goods and services, such as coupons and advertisements that are delivered to a user device.

In accordance with an embodiment of the present system, participating advertisers may install limited range transmitters that provide information on the advertiser that may be used by the user device to identify the participating advertiser. This system does not require any appreciable infrastructure to support the present system since the transmitters need not create a network to operate in accordance with this embodiment. The transmitters need only be enabled to provide an identification of the participating advertiser which is associated with information on the advertiser stored in a database that is accessible by the user device.

For example, as a consumer walks from a first store to a second store, an application executing on the consumer's computing device may sense that a signal strength of the transmitter associated with the first store (e.g., located at the first store) is weakening and that a signal strength of the transmitter associated with the second store (e.g., located at the second store) is increasing. In this way, in accordance with an embodiment of the present system, advertisements from the first store with the weaker signal may be deemphasized in relation to advertisements associated with the second store. For example, an ordering of advertisements rendered on a user interface of a user device may be adjusted such that advertisements from the second store are moved on a list of advertisements rendered on the user device (as discussed in more detail herein below), from below the advertisements associated with the first store to above the advertisements associated with the first store. In this way for example, a rendered ordering of the advertisers on a list may be adjusted such that advertisements from the second store are rendered on the list above advertisements from the first store.

In accordance with a further embodiment of the present system, a transparency of rendered advertisements may be adjusted such that advertisements from a closer advertiser are rendered less transparent than advertisements from an advertiser that is further from the user device. In yet a further embodiment of the present system, advertisements from an advertiser that is further from the user device may be removed from the user device and replaced by advertisements from the closer second advertiser.

1. A method of providing indications of participating advertisers to a portable user device, the method comprising for the portable user device the acts of:
detecting a plurality of transmitters for the participating advertisers in a vicinity of the portable user device;
determining a relative proximity of the portable user device to each of the plurality of the transmitters;
rendering an indication of the transmitters on the portable user device based on the determined relative proximity of each of the plurality of the transmitters;
detecting a change in the relative proximity of the transmitters; and
changing the rendering of the indication of the transmitters on the portable user device based on the detected change in the relative proximity of the transmitters.

2. The method of claim 1, comprising an act of identifying notification information that corresponds to each of the plurality of transmitters, wherein the act of rendering the indication of the transmitters comprises an act of rendering the identified notification information.

3. The method of claim 1, wherein the act of changing the rendering of the transmitters comprises an act of changing a rendered transparency of the indication of a first transmitter, when that first transmitter moves closer to the user device than a previously closer second transmitter, the rendered transparency of its indication changing from more transparent to less transparent than the previously closer second transmitter.

4. The method of claim 1, wherein the act of changing the rendering of the indication comprises an act of changing a rendered size of the indication of a first transmitter, when that first transmitter moves closer to the user device than a previously closer second transmitter, it's the rendered size of its indication changing from smaller to larger than the previously closer second transmitter.

5. The method of claim 1, wherein each of the plurality of transmitters is a beacon device.

6. (canceled)

7. The method of claim 5, wherein the plurality of beacon devices have a same Service Set Identifier (SSID) and a unique Medium Access layer (MAC) address that identifies each of the plurality of transmitters.

8. The method of claim 5, wherein the beacon devices use option fields in an internet protocol (IP) compliant header to identify each of the plurality of the transmitters.

9. The method of claim 5, further comprising acts of:
registering each of the beacon devices at a vendor provisioning portal; and
associating unique notification information for each of the plurality of the beacon device at the vendor provisioning portal, wherein the act of rendering the indication of the transmitters comprises an act of rendering the unique notification information.

10. The method of claim 5, wherein the act of determining the relative proximity and detecting the change in the relative proximity comprise acts of detecting a relative signal strength of each of the beacon devices.

11. (canceled)

12. The method of claim 1, further comprising acts of:
retrieving notifications information of similar transmitters as the plurality of the transmitters; and
rending the notification information of the similar transmitters.

13. The method of claim 12, further comprising an act of providing a comparison of the similar transmitters to the plurality of the transmitters.

14. The method of claim 13, wherein at least one of the plurality of the transmitters being compared has a beacon device and at least one of the similar transmitters is a web based store.

15. (canceled)

16. A portable user device for providing indications of participating advertisers to a user, the portable user device being configured by a program stored on a memory medium to:
detect a plurality of transmitters in a vicinity of the portable user device;
determine a relative proximity of the portable user device to each of the plurality of the transmitters;
render an indication of transmitters based on the determined relative proximity of each of the plurality of the transmitters;
detect a change in the relative proximity of the transmitters; and
change the rendering of the transmitters on the portable user device based on the detected change in the relative proximity of the transmitters.

17. A non-transitory computer readable memory medium comprising a program stored thereon, which configures a processor to perform acts, the program comprising:
a program portion configured to detect a plurality of transmitters in a vicinity of a portable user device;
a program portion configured to determine a relative proximity of the portable user device to each of the plurality of the transmitters;
a program portion configured to render an indication of the transmitters based on the determined relative proximity of each of the plurality of the transmitters;
a program portion configured to detect a change in the relative proximity of the transmitters; and
a program portion configured to change the rendering of the transmitters on the portable user device based on the detected change in the relative proximity of the transmitters.

18. The program of claim 17, further comprising:
a program portion configured to identify notification information that corresponds to each of the plurality of transmitters;
a program portion configured to render the identified notification information when rendering the indication.

19. The portable user device of claim 16, further configured to:
identify notification information that corresponds to each of the plurality of transmitters;
render the identified notification information when rendering the indication.
